(19) United States
(12) Patent Application Publication
(10) Pub. No.: US 2025/0110991 A1
(43) Pub. Date: Apr. 3, 2025

(54) GRAPH REPRESENTATION LEARNING APPROACH FOR EFFICIENT PROVENANCE GRAPH SEARCH

(71) Applicant: Qatar Foundation for Education, Science and Community Development, Doha (QA)

(72) Inventors: Husrev Taha Sencar, Doha (QA); Enes Altinisik, Doha (QA); Fatih Deniz, Doha (QA)

(21) Appl. No.: 18/884,599

(22) Filed: Sep. 13, 2024

Related U.S. Application Data
(60) Provisional application No. 63/538,133, filed on Sep. 13, 2023.

(51) Int. Cl. G06F 16/903; G06F 16/901

(52) U.S. Cl. CPC G06F 16/90335; G06F 16/9024

(57) ABSTRACT

Example systems, methods, and apparatus are disclosed herein for ProvG-Searcher for querying large provenance graph repositories. A system for querying large provenance graph repositories including a server, a processor, and a memory storing instruction that, when executed by the processor, cause the processor to apply an embedding function and apply a subgraph prediction function.

### RELATED APPLICATIONS

The present disclosure claims priority to U.S. Provisional Patent Application 63/538,133 having a filing date of Sep. 13, 2023, the entirety of which is incorporated herein.

### BACKGROUND

Causality analysis and provenance graphs have emerged as crucial tools for understanding and mitigating risks associated with cyber attacks targeting computer systems. A provenance graph is a holistic representation of kernel audit logs, describing interactions between system entities and allowing efficient search for known attack behaviors within vast repositories of historical system logs.

When a threat hunter discovers news of a new attack targeting an organization within the same business vertical as their own, the appropriate course of action is to hypothesize that the attackers may have already infiltrated their systems and to search for traces of an ongoing intrusion in their system logs, which necessitates converting an externally observed threat behavior into a query that can be searched within system-level provenance graphs. This instance of subgraph matching problem involves determining whether a query graph is isomorphic to a subgraph of a larger graph both structurally and in its key features. Recently, graph neural networks (GNNs) have achieved significant success in graph representation learning, which is the learning of an embedding function that maps each graph into an embedding vector encapsulating its key features. The subgraph relation between two graph embeddings is then evaluated in this continuous vector space.

However approximate sub-graph matching methods encounter distinct challenges. Provenance graphs are characterized by a large number of nodes and edges, as well as a high average node degree, due to the diverse activities inherent within a typical computing system. This results in a considerable computational burden when searching behaviors and learning graph relationships. Moreover, the coarse-grained nature of logs hinders precise tracking of information and control flows among system entities, leading to erroneous connections between nodes. These factors render search methods based on node alignment between graphs largely impractical. Applying learning-based methods, based on GNNs, to large graphs introduces further complications. GNNs carry out computation through a series of message-passing iterations, during which nodes gather data from neighboring nodes to update their own information. The updated information of all nodes is then pooled together to create a graph-level representation. In this context, increasing the model depth beyond a few layers (i.e., the number of iterations) to more effectively capture relationships results in an exponential expansion of a GNN's receptive field, which consequently leads to diminished expressivity due to oversmoothing.

Previous hypothesis-driven threat hunting techniques have limitations such that the entire search computation must be performed at the query time and the efficiency declines due to its dependency on the query, particularly as the size of the provenance graph increases. To improve the efficiency of provenance graph analysis, several methods have been proposed for simplifying provenance graphs by identifying anomalous interactions and preserving forensic tractability. Nevertheless, they often do not meet the objective of preserving sufficient integrity to support the search for more general graph patterns.

A need accordingly exists for efficiently and accurately identifying matching subgraphs within a large provenance graph corresponding to a given query graph to address the challenges posed by the size and diversity of relations within provenance graphs.

### SUMMARY

Example systems, methods, and apparatus are disclosed herein for identifying matching subgraphs within a large provenance graph corresponding to a given query graph.

In light of the disclosure herein, and without limiting the scope of the invention in any way, in a first aspect of the present disclosure, which may be combined with any other aspect listed herein unless specified otherwise, a system for querying large provenance graph repositories comprising a server, a processor, and a memory storing instructions, which when executed by the processor, cause the processor to apply an embedding function, and apply a subgraph prediction function.

In a second aspect of the present disclosure, which may be combined with any other aspect listed herein unless specified otherwise, a method for querying large provenance graph repositories comprising receiving kernel logs from a server, converting kernel logs to a graph representation, simplifying the graph representation, versioning nodes in the graph representation, partitioning the nodes into overlapping subgraphs, and identifying a subgraph relation of the overlapping subgraphs.

In a third aspect of the present disclosure, any of the structure, functionality, and alternatives disclosed in connection with any one or more of FIGS. 1 to 10 may be combined with any other structure, functionality, and alternatives disclosed in connection with any other one or more of FIGS. 1 to 10.

In light of the present disclosure and the above aspects, it is therefore an advantage of the present disclosure to provide users with a method for identifying matching subgraphs within a large provenance graph corresponding to a given query graph.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is an overview of a system for identifying matching subgraphs within a large provenance graph corresponding to a given query graph (termed “ProvG-Searcher”) and its key components, according to an example embodiment of the present disclosure.

FIG. 2 is an example provenance graph consisting of processes (♦) and files (°). The node labels represent the names of the files and processes, where the nodes that represent threads of processes P0 and P1 are surrounded by circles and the simplified graph after combining threads is shown on the right side, according to an example embodiment of the present disclosure.

FIG. 3 shows the ego-graph of a process P1 after applying simplification and dependence explosion steps to the initial graph shown in FIG. 2 (left), and the resulting graph after applying behavior-preserving reduction (right), where Algorithm 1 is utilized to identify the recurring behavior, as indicated within the blue boxes, according to an example embodiment of the present disclosure.

FIG. 4 shows ROC curves for validating subgraph relationship between 3-hop graphs using the model (a) on all the datasets; and (b) on the Theia dataset when a random portion of query edges and nodes are removed from the target graphs, according to an example embodiment of the present disclosure.

FIG. 5A-B shows ROC curves for searching generic behaviors in the Theia dataset using (a) ProvG-Searcher and (b) Poirot, considering both exact matching and imprecise matching with a portion of query edges and nodes are removed in the provenance graph, according to an example embodiment of the present disclosure.

FIGS. 6A-6B show a comparison of different GNN architectures, number of layers, and aggregation methods, according to an example embodiment of the present disclosure.

FIGS. 7A-7B show sample (a) negative and (b) positive pairs, i.e., (G−, Gp) and (G+, Gp) pairs defined in the disclosure, according to an example embodiment of the present disclosure.

FIGS. 8A-8B show (a) resulting ROC curves for subgraph matching scores using the present disclosure and (b) resulting ROC curves for subgraph matching scores using a previous approach, according to an example embodiment of the present disclosure.

FIG. 9 shows a comparison of different GNN architectures, number of layers, and aggregation methods on Theia dataset, according to an example embodiment of the present disclosure.

FIG. 10 shows a component diagram of a system for identifying matching subgraphs within a large provenance graph corresponding to a given query graph (termed “ProvG-Searcher”) and its key components, as per FIG. 1, according to an example embodiment of the present disclosure.

### DETAILED DESCRIPTION

Methods, systems, and apparatus are disclosed herein for identifying matching subgraphs within a large provenance graph corresponding to a given query graph.

Reference is made herein to a memory. As disclosed herein, a memory refers to a device that holds electronic data and/or instructions for immediate use by a processor. The memory is able to receive and transmit data.

Reference is made herein to a processor. As disclosed herein, a processor refers to a device that executes instructions stored by the memory. The memory receives and transmits data.

While the example methods, apparatus, and systems are disclosed herein for identifying matching subgraphs within a large provenance graph corresponding to a given query graph, it should be appreciated that the methods, apparatus, and systems may be operable for other applications.

### System Design and Methodology

The disclosed method to hypothesis-driven threat hunting utilizes provenance graphs and frames the task as a subgraph entailment problem. Provenance graphs depict audit logs as labeled, typed, and directed graphs, where nodes represent system entities and directed edges indicate transformation or flow of information due to distinct system calls. Timestamps assigned to each node and edge capture the graph's evolving nature. The disclosed method aims to effectively identify system behaviors of interest by representing queries as graphs and searching for them within the larger context of the provenance graph.

A graph G is defined as a set of nodes V={v1, . . . , vN} and a set of edges E={e1, . . . , eM} where each node and each edge are associated with a type. Given a target and a query graph, the solution to the graph entailment problem involves detecting every query instance in the target. Since exact subgraph matching on graphs with the scale of provenance graphs is not feasible, an approximate matching method is employed to make subgraph predictions. The disclosed method involves a sequence of steps that reduce the size of a graph while ensuring that the system behavior is preserved at a higher level of abstraction.

Following this reduction, let G represent a reduced provenance graph. G is decomposed into a set of overlapping subgraphs by extracting the k-hop ego-graph Gp of each process node p∈VP. Given the set of ego-graphs P={Gp|Gp⊆G}, an embedding function η is learned: Gp→Rd that maps each ego-graph to a d-dimensional representation z∈Rd, capturing the key structural information of a graph for use in conjunction with a suitable sub-graph prediction function φ. Hence, the encoder must incorporate an inductive bias to effectively represent the subgraph relationship while learning a mapping in which the subgraph prediction function φ (zp, zq) serves as a vector-based measure to confirm the existence or absence of this relation. It must further be noted that since provenance graphs are typically very large, φ (zp, zq) needs to be evaluated over all zp values for a given zq. Therefore, effective computation of φ (zp, zq) is very critical.

A subgraph embedding function is employed that effectively addresses both issues. The notion of order embedding is utilized, which aims to encode the ordering properties among entities into target representation space. Order embeddings specifically model hierarchical relations with anti-symmetry and partial-order transitivity, which are inherent to subgraph relationships. To develop the embedding function η, an inductive graph neural network is utilized and applied the order embedding technique. This approach enables learning a geometrically structured embedding space that effectively represents the relationships between subgraphs. At the query execution state, the encoder η is applied independently to the query graph GQ. This is done by identifying ego-graphs Q={Gq|Gq⊆GQ} corresponding to all anchor nodes q∈VQ and computing the embeddings zq=η(Gq) for all ego-graphs in Q.

Then, the subgraph prediction function is evaluated by considering the newly computed embeddings zq from the query and the precomputed subgraph embeddings zp. This involves identifying (p, q) node pairs that satisfy the subgraph relation φ (zp, zq). To determine whether one graph is a subgraph of another, one can simply check that all neighbors of q∈VQ satisfy the subgraph relationship. However, such a comparison enforces an exact match of the query, which cannot handle cases where discrepancies exist between the query and the logs. To address this issue and achieve greater generality, the use of a soft-decision metric is defined as follows:

$${𝒢}_{Q} ⊆ {𝒢}_{P} iff g ( {𝒢}_{p}^{⋆} , {𝒢}_{Q} ) \geq τ where \qquad ( 1 )$$

$${𝒢}_{p}^{q} = \{ ⋃ {𝒢}_{P} \vert {∀}_{q} ϵ {V}_{Q} , φ ( {z}_{p} , {z}_{q} ) is satisfied \}$$

Here, Gp* represents a graph obtained by combining all ego-graphs Gp that satisfy the subgraph relationship with the query ego-graphs of GQ, and g (.,.) is a scoring function that computes the intersection of G and the query graph GQ.

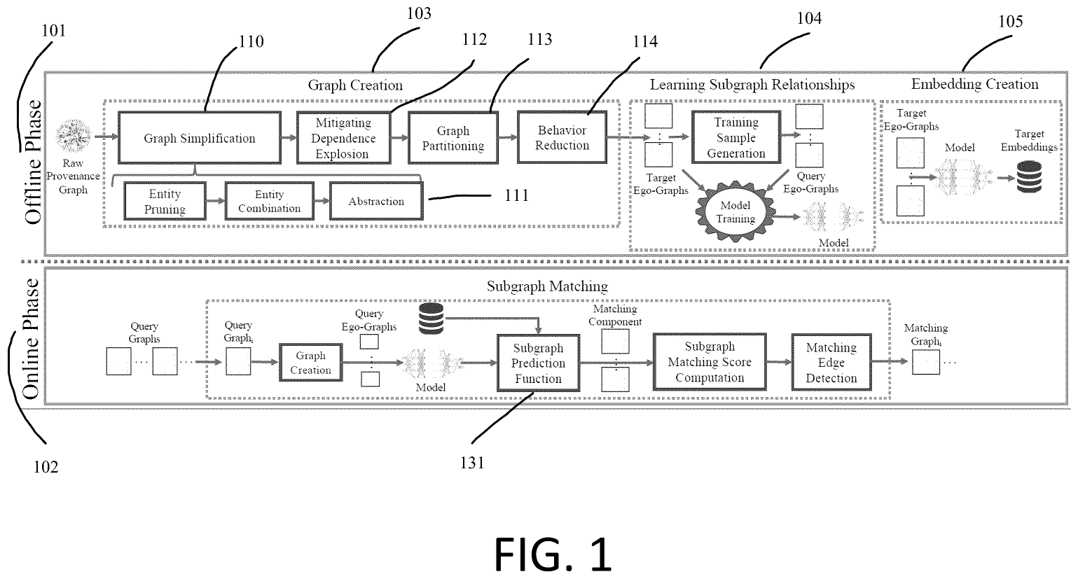

FIG. 1 shows a system level diagram of a system 100 for identifying matching subgraphs within a large provenance graph corresponding to a given query graph. The system 100 includes an offline phase 101 and an online phase 102. The offline phase 101 collects audit logs to create a provenance graph. The offline phase 101 includes a graph creation 103, learning subgraph relationships 104, and an embedding creation 105. The online phase 102 includes a subgraph matching score computation 131.

The graph creation 103 includes a graph simplification 110, a mitigating dependence explosion 112, a graph portioning 113, and a behavior reduction 114. The graph creation 103 processes raw system logs through multiple reduction steps before constructing a streamlined provenance graph that represents various interactions between subjects and objects and produces a partitioned version of this graph. Examples of subjects may include but are not limited to processes. Examples of objects may include but are not limited to processes, files, and network sockets.

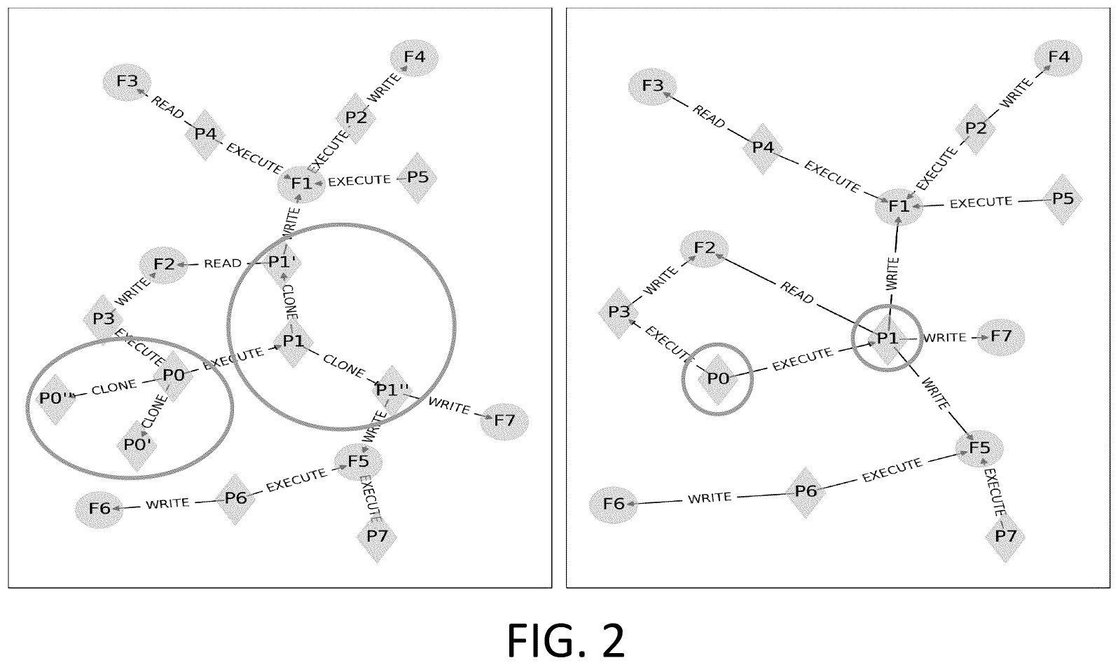

The graph simplification 110 is configured to maintain all read, write, and modify attribute events for processes, files, sockets, and registries. The graph simplification 110 may also be configured to preserve clone, fork, or execute events for processes, while removing open and close events to avoid redundancy, as they precede or follow read or write events. A key challenge in provenance graph creation is the handling of threads. Applications often use threads to enhance performance and scalability, but query graphs might not exhibit this behavior. To ensure consistency across both graphs, the disclosed method merges threads into their parent process as illustrated in FIG. 2.

In other instances, the graph simplification 110 may be configured to capture changes in the behavior of remote servers over time, treating each remote IP and port combination as a distinct source within 10-minute time windows.

The graph simplification 110 also includes a system directory-based abstraction 111 is used for all system entities, except for network objects. As such, category labels are assigned to each entity based on its root directory in the file system, indicating a higher-level function for each entity. In other instances, network objects are abstracted based on their source IP, destination IP, and destination port. Each IP address is categorized as public, private, or local based on its usage, while ports are categorized as reserved if they are less than 1024 and as user otherwise. Overall, this leads to the use of more than 70 abstraction categories, which are summarized in Tables 4-6. It is crucial that system entities and their interactions are represented consistently across both the query and provenance graphs. A discrepancy in these representations could hinder the model's generalization capability. This is particularly concerning when the query lacks the granularity and detail typically found in system logs, potentially leading to mismatches or misinterpretations when comparing the query and provenance graphs. For example, a browser process in the query may correspond to one of several processes, such as Firefox, Chrome, or Safari, in the provenance graph. Similarly, two files with the same name may be associated with different functions in the context of different applications.

### A Abstraction Categories

TABLE 4
Process and File Abstraction Categories
for Linux Operating System

bin, cache, com, data, dbus-vfs-daemon, dev, devd, digit, dns,
etc, home, lib, lib64, man, other, proc, root, run, sbin, stream,
sys, tmp, unknown, usr, usrbin, var, vi, www,

TABLE 5
Process and File Abstraction Categories
for Windows Operating System

c: program files, c: program files (x86), c: programdata, c: users,
c: windows, device, program files, program files (x86), programdata,
registry, systemroot, users, windows, c: deploy-keys, c: hvabeat,
c: program, c: program files, c: program files (x86), c: programdata,
c: recovery, c: system volume information, c: tcssl, c: users,
c: windows, d: extend, d: recycle.bin, d: system volume information

TABLE 6
Abstraction Categories for Network Objects

inter_private_inter, user_local_user, user_private_user,
user_private_reserved, user_public_inter, user_public_user,
user_public_reserved, reserved_local_user, reserved_local_reserved,
reserved_private_user, reserved_private_reserved,
reserved_public_user

In one embodiment, when object nodes—such as files, network sockets, and registry entries—within the same abstraction category are connected to a single subject (process) node through a shared event type, the abstraction 111 is configured to merge these nodes into one node with the same object abstraction. Abstracting system entities not only helps reveal recurring patterns in a graph but also allows for further reduction in graph complexity. Since these nodes are connected to only one process, this procedure preserves the causality relationships between nodes. To maintain causality relationships during deduplication, the timestamp of the first event is kept if the flow starts from a process to an object and the timestamp of the last event if the flow originates from an object and leads to a process. Examples of the flow may include but are not limited to write or attribute modifications.

The mitigating dependence explosion 112 is configured to leverage the available event timestamp information to impose a timing constraint on the flows. The mitigating dependence explosion 112, caused by high in-degree and out-degree nodes in a provenance graph, significantly impedes the learning of subgraph relationships. This is because tracing through such nodes leads to an exponential increase in the possible node interactions that must be considered. Two strategies address this problem while extracting ego-graphs from the provenance graph. In some embodiments, time dependencies are encoded into the provenance graph by creating a new version of a node whenever the corresponding system entity receives new information, which ensures that all paths in the extracted ego-graphs have edges with monotonically increasing timestamp values, thereby preserving the causal order of events and allows the elimination of repeated events between two versioned nodes. It is worth noting that incorporating node versioning in provenance graphs does not necessitate the inclusion of edge timestamps in the query graph.

The mitigation dependence explosion 112 is also configured to designate specific nodes as sink nodes to effectively prevent non-informative information flows, leading to more accurate and meaningful learning of subgraph relationships. In some embodiments, non-process nodes with zero in-degree or out-degree, such as log files written to by all processes without reads, or configuration files that are only read, are also considered sink nodes. Notably, interactions with high-degree nodes, such as DNS server IP addresses or cache files, do not provide discriminative information that aids in learning subgraph relationships. Moreover, any system entity interacting with these high-degree nodes will appear to receive information from numerous other system entities. This contributes to the oversmoothing phenomenon, as it results in an expanded receptive field for a GNN. This is because there is no flow of information between the neighbors of these nodes, making their role in understanding subgraph relationships less significant.

The graph partitioning 113 is configured to partition the graph into overlapping subgraphs by extracting the k-hop ego-graph of each process node. As such, k also signifies the number of GNN layers used to obtain a subgraph representation. An ego-graph with depth k, centered around node v, is an induced subgraph that includes v and all nodes within a distance k from it. In fact, any pattern with a radius I≤k can be found within an ego-graph of depth k, where the values l and k can be determined based on the query graphs' characteristics. To extract ego-graphs, a dynamic programming algorithm is used as presented in the Algorithm 2. This algorithm is used to extract all ego-graphs of process nodes, i.e., Gp, from the provenance graph GP. The algorithm aggregates each versioned node's forward, and backward neighbors starting from 0-hop distance and extending to neighbors at kFfid-hop distance, where the 0-hop neighbor refers to the node itself. The l-hop neighbors of a node are aggregated from (l−1)-hop neighbors of the corresponding node's neighbors, except for versioned neighbors where different versions of the same node are considered to be at the same depth. It must be noted that, for forward neighbors, the node with the next version, and for backward neighbors, the node with the previous version, are the only neighbors that can be reachable. Additionally, only the 0-hop neighbors of object nodes with 0 in- or out-degree are computed, which are added to sink nodes since they can only be reached in 1-hop.

Algorithm 2 Dynamic algorithm for provenance graph partitioning.

Require: [symbol] [symbol] reduced provenance graph, k: ego-graph hop count,
S: set of sink nodes, [symbol] [symbol] process nodes
Ensure: [symbol] [symbol] k-hop ego-graphs

| | |
|---|---|
| 1: | for all p ϵ [symbol] do |
| 2: | neigh[p][ [symbol] forward [symbol] ] ← p |
| 3: | neigh[p][ [symbol] backward [symbol] ] ← p |
| 4: | end for |
| 5: | for [symbol] = 1 [symbol] k do |
| 6: | for all n ϵ [symbol] do |
| 7: | if n ϵ S then |
| 8: | neigh[n][ [symbol] forward [symbol] ][0] ← p |
| 9: | neigh[n][ [symbol] backward [symbol] ][0] ← p |
| 10 | else |
| 11: | (Calculate forward neighbours) |
| 12: | for all w ϵ ln(n) do |
| 13: | neigh[n][ [symbol] forw [symbol] ][l]+ ← neigh[w][ [symbol] forw [symbol] ] |
| | [l − 1] |
| 14: | end for |
| 15: | [symbol] = get_next_version(n) |
| 16: | neigh[n][ [symbol] forw [symbol] ][l]+ ← neigh[nn][ [symbol] forw [symbol] ][l] |
| 17: | (Calculate backward neighbours) |
| 18: | for all w ϵ Out(n) do |
| 19: | neigh[n][ [symbol] back [symbol] ][l]+ ← neigh[w][ [symbol] back [symbol] ] |
| | [l − 1] |
| 20: | end for |
| 21: | pn = get_prev_version(n) |
| 22: | neigh[n][ [symbol] back [symbol] ][l]+ ← neigh[pn][ [symbol] back [symbol] ][l] |
| 23: | end if |
| 24: | end for |
| 25: | end for |
| 26: | for all p ϵ [symbol] [symbol] do |
| 27: | [symbol] [symbol] ← neigh[p][ [symbol] forw [symbol] ][k] → neigh[p] |
| | [ [symbol] back [symbol] ][k] |
| 28: | end for |

[symbol]

indicates data missing or illegible when filed

The function ln(n) returns all incoming neighbors of node n, while Out (n) is used to obtain the outgoing neighbors. For a versioned node n with version i, neighbors of node ni+1 are aggregated to calculate its forward neighbors and the neighbors of node ni−1 to determine its backward neighbors. The functions get_next_version(n) and get_prev_version(n) are used within the algorithm to retrieve the next and previous versions of node n, respectively.

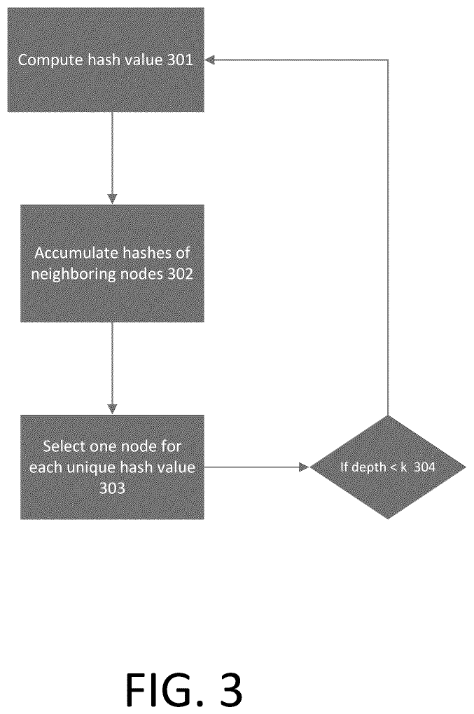

The behaviors reduction 114 is configured to remove repeated behaviors using an iterative label propagation as further discussed in FIG. 3. To take advantage of this, the reduced provenance graph, containing versioned and sink nodes, is partitioned into subgraphs by extracting the ego-graph of each process node which are crucial for understanding the system behavior. Even though this step is performed once, since provenance graphs grow dynamically, it is essential for this task to be as efficient as possible.

At this stage, resulting ego-graphs may still contain redundant information. For instance, consider an ego-graph showing a user process that has written to hundreds of var directory files, possibly in different contexts. A given query involving this user process, however, is likely to be relevant to only one of these contexts. Therefore, from a search perspective, a user process writing to a var directory is more in-formative than tracking the number of written files. Moreover, as repeated events can dominate the information aggregation step, GNNs may primarily learn those repetitive behaviors while neglecting less frequent ones. To avoid the suppression of observed system behaviors, it is necessary to identify and eliminate recurring patterns within each ego-graph.

The learning subgraph relationships 104 is configured to employ a k-layer GNN to learn a representation of the subgraph relation by training it on positive and negative pairs of graphs to learn an inductive embedding function that will be used in conjunction with a subgraph prediction function. Order embeddings is utilized to provide a natural way to model transitive relational data such as entailing graphs. These embeddings essentially obey a structural constraint whereby Gq is deemed a subgraph of Gp if and only if all the coordinate values of zp are higher than zq's.

Order embeddings ensure the preservation of partial ordering between elements by maintaining the order relations of coordinates in the embedded space such that for two graphs Gp and Gq and their embeddings zp, zq∈Rd

$${𝒢}_{q} ⊆ {𝒢}_{p} if and only if {∀}_{i = 1}^{d} {z}_{pi} \geq {z}_{qi} . \qquad ( 2 )$$

Gq is a subgraph of Gp if and only if all the coordinate values of zp are higher than zq's. An order violation penalty function imposes this constraint on the learned relation to measure the extent to which two embeddings violate their order, i.e., E (zq, zp)≠0 if Eq. (2) is not satisfied.

$$E ( {z}_{p} , {z}_{q} ) = ‖ max \{ 0 , {z}_{p} - {z}_{q} \} {‖}^{2} \qquad ( 3 )$$

Consequently, GNN is optimized to minimize the order violation penalty to learn an approximate order embedding function using the following max-margin loss where S+ denotes a set of positive graph pairs that satisfy the subgraph relation, and S− is the set of negative pairs for which this relation is not satisfied.

$$ℒ ( {z}_{p} , {z}_{q} ) = {Σ}_{( {z}_{p} , {z}_{q} ) ϵ {𝒮}^{+}} E ( {z}_{p} , {z}_{q} ) + {Σ}_{( {z}_{{q}^{′}} , {z}_{{p}^{′}} ) ϵ {𝒮}^{-}} max \{ 0 , α - E ( {z}_{{q}^{′}} , {z}_{{p}^{′}} ) \} \qquad ( 4 )$$

This loss crucially encourages positive samples to have zero penalty and negative samples to have a penalty greater than a margin α, thereby ensuring that two embeddings have a violation penalty of α if the subgraph relation does not hold. Thus, the subgraph prediction function introduced in Eq. (1) becomes a proxy for the order violation penalty, i.e., φ(zp, zq)=E (zq, zp). In an alternate embodiment, a neural network model is utilized to learn the intrinsic relationship between embeddings zq and zp of entailing graphs as a representation for φ(zp, zq). Subgraph relationship essentially imposes a hierarchy over graphs. Therefore, a vector representation for subgraphs should take into account the structure of this hierarchy to effectively evaluate the relationship between two graphs.

The learning subgraph relationships 104 further includes a training sample generation 121. The training sample generation 121 requires positive and negative pairs of query and target graphs. These pairs can be represented as (Gq+, Gp) and (Gq−, Gp,) where Gq+ is a subgraph of Gp and G− is not. In some embodiments, the model first computes embeddings for all graphs in a batch of positive and negative pairs, then evaluates the resulting loss as defined in Eq. (4). This loss is backpropagated to update the network weights and minimize its value.

The training sample generation 121 is also configured to choose Gp as an ego-graph of anode vp within a reduced provenance graph GP to ensure generalization. The expressive power of GNNs is known to increase when node and edge features become more distinct. To take advantage of this, it is essential to assign suitable node and edge features. Two crucial factors are considered when creating a paired query graph. The first is the size of the query graphs. In some embodiments, the size of reduced query graphs is limited to 10-15 edges considering 3-hop ego-graphs. In an alternate embodiment, in unreduced query graphs, this may correspond to 40-50 edges as discussed in the findings of Table 1. The second factor is the strategy employed to generate Gq+ and Gq−. Gq+, is created involves subsampling a set of nodes or edges from Gp and extracting the corresponding node or edge-induced graph. However, a random selection scheme could expose the model to repetitive behaviors and lead to overfitting common graph patterns. As for Gq−, choosing a graph at random may not only generate easy negative samples but also inadvertently yield an actual subgraph of Gp, particularly when Gp is large. Consequently, a graph sampling method based on path frequency is used.

TABLE 1
Reduction in Ego-Graph Size During Graph Creation
Process (GS: Graph Simplification, DEM: Dependence
Exploision Mitigation, BR: Behavior-Preserving Reduction)

| | Initial | | | | GS (Sec. 4.1.1) | | | | DEM (Sec. 4.1.2) | | BR (Sec. 4.1.4) | |
|---|---|---|---|---|---|---|---|---|---|---|---|---|
| Dataset | N | | E | | N | | E | | N | E | N | E |
| Theia | 206 | k | 13 | M | 22 | k | 6.9 | M | 159 | 336 | 19 | 38 |
| Trace | 29 | k | 490 | k | 400 | | 1461 | | 329 | 1303 | 16 | 28 |
| Cadets | 5 | k | 160 | k | 1.9 | k | 76 | k | 43 | 75 | 12 | 15 |
| FiveDirection | 25 | k | 8.7 | M | 2.1 | k | 4.2 | M | 350 | 1034 | 71 | 527 |

GNNs are expressed as message-passing networks that rely on three key functions, namely MSG, AGG, and UPDATE. These functions work together to transfer information between the different components of the network and update their embeddings. In some embodiments, these functions operate at the node level, exchanging messages between a node vi and its immediate neighboring nodes Nvi. In layer l, a message between two nodes (vi, vj) depends on the previous layer's hidden representations hl−1, i.e., mli j=MSG (h). Then, AGG combines the messages from Nvi with hl−1 to produceivi's representation for layer l in UPDATE. A multi-relational GNN that can also incorporate information by considering both edge type and edge direction relations is deployed. Two separate one-hot encoding representations for each object type and abstraction category are employed, and the node features for both the provenance and query graphs are determined in the same way.

During the prediction stage, the query graph undergoes the same processing steps as the provenance graph and is partitioned into subgraphs. Afterward, the order relations between the query ego-graph embeddings and the precomputed ego-graph embeddings in the provenance graph are computed to determine whether the subgraph relation exists.

The subgraph matching score computation 131 relies on two measures to achieve robustness against inexact queries, in some embodiments where the query may not precisely match the system events being searched for. The first measure is utilized when assessing the subgraph relationship between two ego-graphs, as defined in Eq. (5), by permitting a certain degree of order violation, i.e., 4 (zp, zq)=E (zq, zp)≤τovp. The second measure allows for partial matching of the query graph within the provenance graph, which is achieved by using a graph intersection-based scoring function. The graph G*, as described in Eq. (1), is the union of all possible matches Gp to GQ and may contain several disconnected parts. The scoring function intersects the query graph with each connected component (CC) of G* and utilizes the ratio of edges in the intersected graphs to the total number of edges in GQ| to compute the final matching score, as defined below:

$$g ( {𝒢}^{⋆} , {𝒢}_{Q} ) = max ( \{ \frac{\vert {𝒢}_{1}^{⋆} ⋂ {𝒢}_{Q} \vert}{\vert {𝒢}_{Q} \vert} ... .. \frac{\vert {𝒢}_{n}^{⋆} ⋂ {𝒢}_{Q} \vert}{\vert {𝒢}_{Q} \vert} \} , τ ) \qquad ( 5 )$$

where CC( [symbol] *)={ [symbol] ₁*, . . . , [symbol] ₙ*} and(S)
max(S,τ={max(S) is max(S)>r,0 otherwise}.

The connected component that yields the highest score above the threshold τ, together with its intersected edges, is identified as the matching subgraph corresponding to the query. The intersected edge-induced graph extracted from this connected component is returned as a response to the query.

FIG. 2 is an example provenance graph consisting of processes (♦) and files (°). The node labels represent the names of the files and processes, where the nodes that represent threads of processes P0 and P1 are surrounded by circles and the simplified graph after combining threads is shown on the right side.

FIG. 3 is a flow diagram of an example procedure 300 for collapsing the node versions back onto original nodes in the behavior reduction 114 of FIG. 1. The behavior reduction 114 starts from the anchor node of an ego-graph. A hash value for each node is computed by aggregating edges with their neighboring nodes' hash values (block 301). For each node, the abstraction category of the node is assigned as its 0-hop hash, and the hashes of neighboring nodes are accumulated from incoming and outgoing edges using the following equation (block 302):

$$nh [ n ] [ forw ] [ l ] = hash ( {Σ}_{e , v ∈ In ( n )} ( e + nh [ v ] [ forw ] [ l - 1 ] ) ) ,$$

$$nh [ n ] [ back ] [ l ] = hash ( {Σ}_{e , v ∈ Out ( n )} ( e + nh [ v ] [ back ] [ l - 1 ] ) ) .$$

Here, nh[n] [f orw][l] and nh[n] [back] [I] represent the hash values of node n at l-hop distance in the forward and backward directions, respectively. The function hash( ) is the SHA-256 function that takes a string as an input and returns a cryptographic hash value. The function ln(n)e is used to retrieve all incoming edges with their source nodes for a given input node n, while Out (n)e all outgoing edges and their target nodes. The set function Σ returns the unique strings in its input in sorted order.

At each depth l, the disclosed method determines all unique (k−l) hash values of the neighbor nodes and select one node for each unique hash value (block 303). These selected nodes form the set of unique nodes for that depth. This process is repeated at all depths up to k and obtain a set of unique nodes for the entire ego-graph (block 304). Using these unique nodes, a reduced ego-graph is created to preserves the behavior of the original graph. The detailed steps of behavior-preserving reduction are provided in Algorithm 1. The random_select function takes a list of nodes as input and returns one random node from the input list, and the subgraph function is used to create a reduced graph with the input nodes. This leaves unique traits in each subgraph to learn as part of a subgraph relation.

Algorithm 1 Behavior-Preserving Graph Reduction Method

Require: [symbol] ₚ: ego-graph of anchor node vₚ, nh: hashes of node n
Ensure: [symbol] ₚ: reduced ego-graph of anchor node nₚ

| | |
|---|---|
| 1: | forward ← Vₚ |
| 2: | for l = 0, [symbol] k do |
| 3: | unique ← dict( ) |
| 4: | for all e, [symbol] ϵ [symbol] (forward) do |
| 5: | unique[ [symbol] + nh[v][ [symbol] forw [symbol] ][k − l].append(v) |
| 6: | end for |
| 7: | for all hash ϵ unique do |
| 8: | forward.append(random_select(unique[hash]) |
| 9: | end for |
| 10 | end for |
| 11: | backward ← Vₚ |
| 12: | for l = 0 [symbol] k do |
| 13: | unique ← dict( ) |
| 14: | for all e, [symbol] ϵ Outₑ(backward) do |
| 15: | unique[e + nh[v][ [symbol] back [symbol] ][k − l]].append(v) |
| 16: | end for |
| 17: | for all hash ϵ unique do |
| 18: | backward.append(random_select(unique[hash]) |
| 19: | end for |
| 20: | end for |
| 21: | unique_nodes ← forward\|backward |
| 22: | [symbol] ₚ ← [symbol] ₚ [symbol] subgraph(unique_nodes) |

[symbol]

indicates data missing or illegible when filed

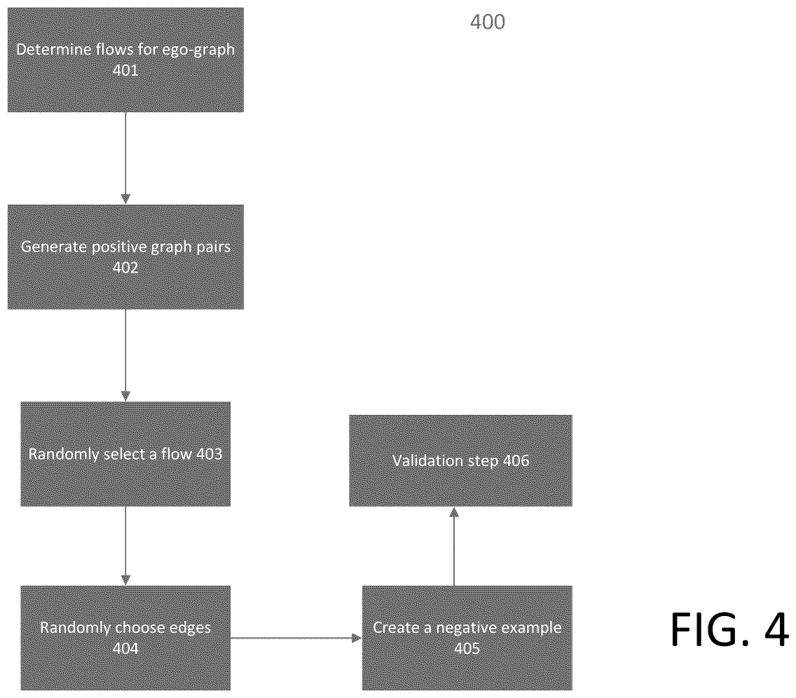

FIG. 4 is a flow diagram of an example procedure 400 for generating positive and negative graph pairs in the training sample generation 121 of FIG. 1. Although the procedure 400 is described with reference to the flow diagram illustrated in FIG. 4, it should be appreciated that many other methods of performing the steps associated with the procedure 400 may be used.

The example procedure 400 begins when possible flows for each ego-graph, Gp∈GP, are determined via forward and backward depth-first search around the anchor node vp, where a flow represents a path between two nodes of Gp that passes through vp (block 401). To generate positive graph pairs, the unique flows for each ego-graph Gp belonging to the same process path are counted (block 402). Then, for each Gp, a flow from all its flows is randomly selected based on their inversely weighted frequency in all ego-graphs of the same path (block 403). Once the flow is selected, it is expanded by randomly choosing some incoming and outgoing edges of the nodes in the selected flow until the desired number of edges is reached (block 404).

An arbitrary flow is identified from the list of known unique flows, which is not contained within the target Gp, and use the corresponding process's ego-graph to expand this flow which may result in a very easy example for the model. Creating a negative example is picking a flow from an ego-graph with the same anchor process as the target graph and expand from it (block 405). Examples of creating a negative example may include but are not limited to, for a Firefox process, choose an ego-graph of another Firefox process and subsample it. In some embodiments, if there are not many instances of the same process. the same behavior may potentially be used to generate many negative examples, thereby biasing the model, thus the behavior of another process with the same abstraction is utilized, i.e., using a Chrome process instead of a Firefox. In an alternate embodiment, a random flow is picked and expand from it. Creating a negative example is more challenging as one needs to avoid introducing both superficial and unlikely behaviors to Gp−. One can indeed create a hard negative example Gq by synthetically adding edges and nodes to a target graph Gp to violate the subgraph relationship. However, this may result in implausible behaviors.

An independent validation step is applied to ensure that the generated (Gq−, Gp) pairs violate the subgraph relationship (block 406). First, if any node or edge abstraction is present in Gq but absent in Gp and if all categories of system entities are indeed found within Gp, all 1- and 2-hop flows in the query graphs are analyzed, taking both edge types and node abstractions into account (block 407). Should at least one distinct flow fail to meet the subgraph relationship criteria, the pair is deemed a negative sample (block 408).

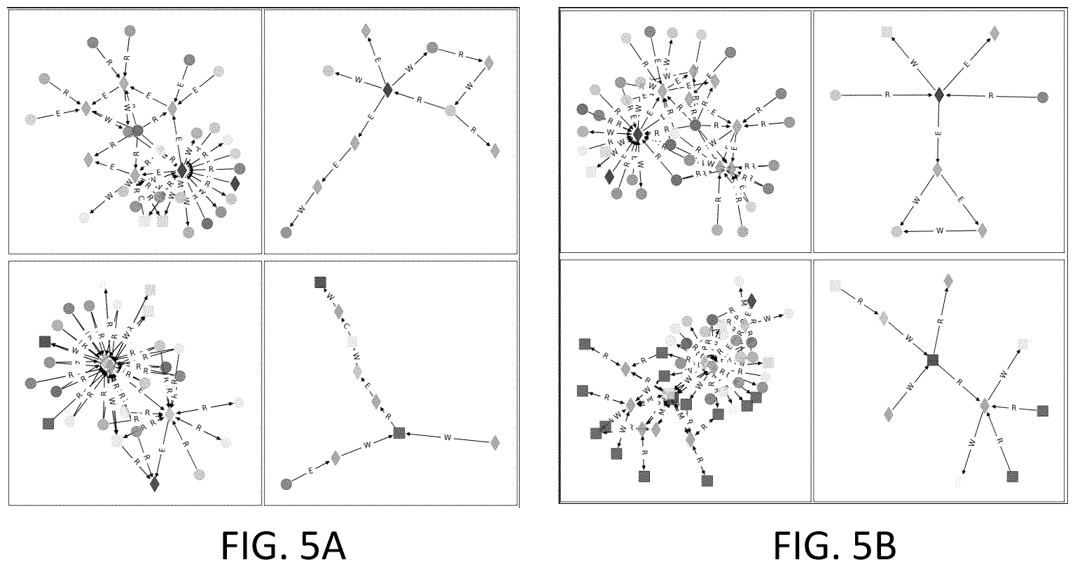

FIG. 5A shows sample negative pairs, i.e., (G−, Gp) pairs defined in the disclosure and FIG. 5B shows sample positive pairs, i.e., (G+, Gp) pairs defined in the disclosure.

### Disclosed Method Testing and Evaluation

Four DARPA TC datasets-Theia, Trace, Cadets, and FiveDirections—which feature eight distinct at-tack scenarios are used to evaluate the disclosed method. The Theia dataset was collected from hosts operating on Ubuntu 12.04, the Trace dataset was collected from hosts operating on Ubuntu 14.04, the Cadets dataset was obtained from a FreeBSD 11.0 host, and the FiveDirections dataset was collected from a Windows 7 machine. The attack scenarios used to evaluate the disclosed method include an Nginx server backdoor, a Firefox backdoor, a backdoor with one of Firefox's extensions (password manager), and a phishing email with a malicious Excel document.

The efficiency of the graph reduction strategies is evaluated. Subsequently, the capacity of order embeddings to represent subgraph relationships using DARPA TC datasets is assessed. Next, the ability to search for and identify subgraphs with two types of queries is examined: those derived from converting DARPA TC attack logs into query graphs and those representing generic system activities.

The effectiveness of the graph creation 103 is demonstrated in terms of reduction in the graph size. Table 1 summarizes the results obtained for each dataset, where the average count of nodes and edges in 3-hop ego-graphs of process nodes are computed. The first column of the table presents the average number of nodes and edges in each ego-graph after the graph simplification steps, up until the entity abstraction is applied as further discussed in FIG. 1. Since DeepHunter also applies these steps citewei2021deephunter, this is used as starting point. The provenance graph is processed by applying all remaining graph reduction steps. The results show a substantial reduction in the ego-graph size across all datasets. For instance, on the Theia dataset, the ego-graphs initially contain 206K nodes and 13 M edges, while the final ego-graphs contain only 19 nodes and 38 edges, on average. The variation across datasets can be attributed to the nature of graphs where the node degrees are much smaller in the Trace and Cadets dataset. These results demonstrate the effectiveness of the disclosed method in reducing the size of ego-graphs while still preserving the diverse behaviors exhibited by processes. In fact, several reduced ego-graphs Gp are duplicated, containing identical nodes and edges. To ensure all graph relationships are learned on an equal footing, regardless of their prevalence, only one sample from each set of repeated ego-graphs is retained. This reduces the total number of ego graphs from 15 k, 235 k, 195 k, and 17 k to 1 k, 11 k, 3 k, and 3 k for Theia, Trace, Cadets, and FiveDirection datasets, respectively.

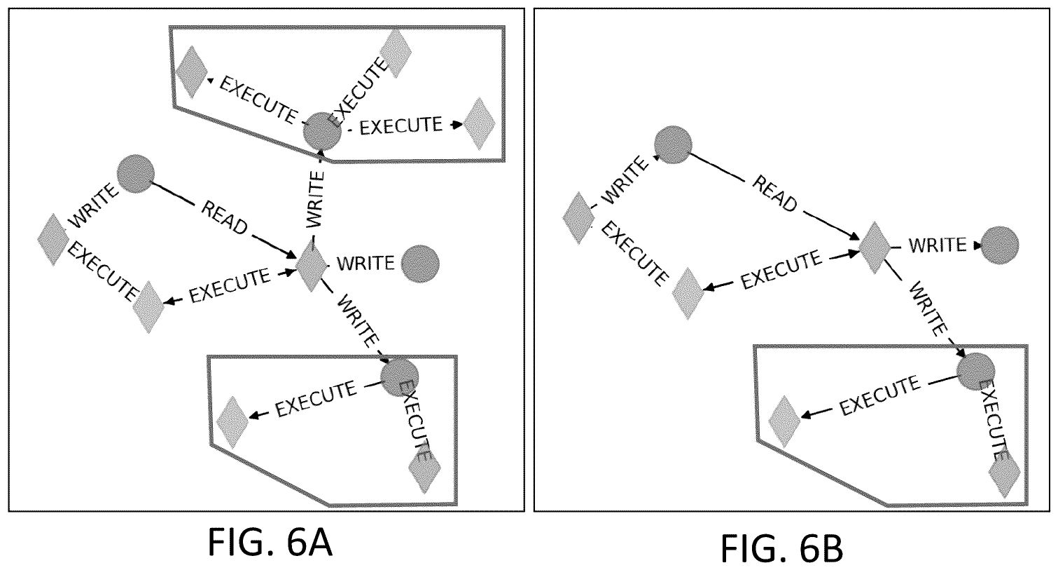

FIG. 6A shows the ego-graph of a process P1 after applying simplification and dependence explosion steps to the initial graph shown in FIG. 2. FIG. 6B shows the resulting graph after applying behavior-preserving reduction, where Algorithm 1 is utilized to identify the recurring behavior, as indicated within the blue boxes.

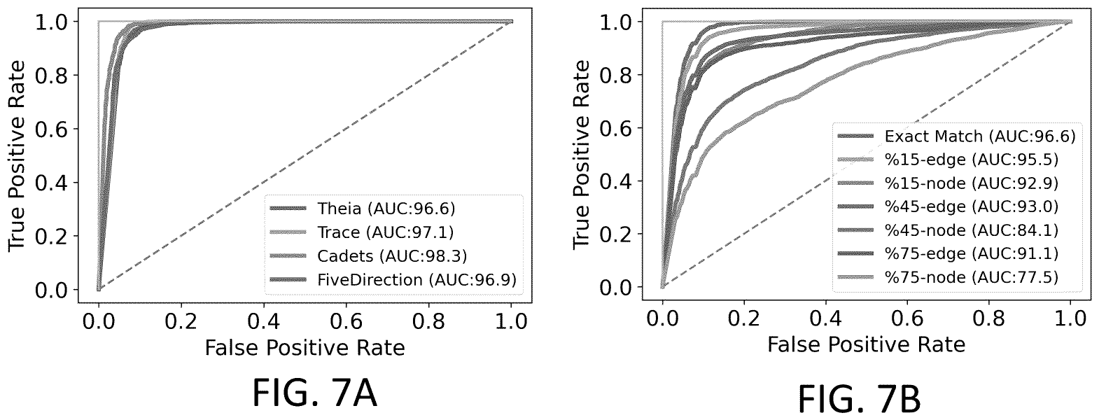

FIG. 7A shows the ROC curves that illustrate the ability of order embeddings to detect subgraph relationships among 3-hop graphs. A separate model for each dataset is trained to learn the subgraph prediction function, i.e., φ (zp, zq). A 3-layer multi-relational Graph-Sage GNN architecture with add pooling and an embedding size of 256 is employed. The ROC curves indicate that the disclosed method exhibits strong performance, with AUC scores ranging from 96.6 to 98.3 across the datasets, effectively distinguishing positive queries from negative ones in the provenance graph.

FIG. 7B shows the ROC curves indicating that order embeddings perform well up to a certain threshold. The same set of test samples from the Theia dataset is used to examine the robustness properties of order embeddings and reassess the performance by removing a randomly selected certain number of nodes and edges from the target graph that are present in the positive queries. This allows evaluating how subgraph matching performance degrades under discrepancies between the query and target. Specifically, the disclosed method achieves AUC scores of 92.9 and 93.0, up to the elimination of 15% of the query nodes and 45% of the query edges from the target graphs, respectively. From these findings, it can be inferred that the disclosed method is capable of handling imprecise queries.

Relatedly, the performance of ProvG-Searcher in accurately determining whether a query graph is entailed within a provenance graph by computing the subgraph matching scores, Eq. (6), between the query and the target graphs is tested. The models generated earlier to evaluate the subgraph relations among 3-hop graphs are used. Their performance on two sets are tested: (i) attack queries underlying DARPA-TC datasets, and (ii) a new test set comprising 5-hop ego-graphs involving generic behaviors extracted from the test portion of the Theia dataset.

The DARPA-TC dataset consists of eight attack scenarios, each consisting of up to three processes. First, the subgraph prediction function is evaluated, which involves extracting and searching process-centric ego-graphs from the query graph within the corresponding provenance graphs. Table 2 displays the number of matching ego-graphs compared to the total number associated with each process in the provenance graph. For instance, process P1 has 846 instances within the provenance graph in the TRACE dataset's attack query. The subgraph prediction function identifies only two, or 2/846, as matching candidates. Notably, no missed matches are observed in any of the test scenarios. Upon analyzing the false matches, all returned ego-graphs are connected, and on average, 78.9% of all query nodes appear in those ego-graphs. A comparison between the number of query nodes in correctly-matching and incorrectly-matching ego-graphs reveals that the former contain, on average, 57% more query nodes.

TABLE 2
Number of Matches Identified Per Query Ego-Graph

| Dataset | Query | P1 | P2 | P3 |
|---|---|---|---|---|
| Theia | Q1 | 2/846 | 1/1 | 1/1 |
| Trace | Q2 | 1/21023 | 1/1 | — |
| | Q3 | 1/239 | 1/2 | — |
| Cadets | Q4 | 3/15 | 1/1 | — |
| | Q5 | 1/15 | 1/1 | — |
| | Q6 | 2/15 | 3/4 | 1/2 |
| Five Direction | Q7 | 6/724 | — | — |
| | Q8 | 9/724 | 3/10 | 1/1 |

This indicates that the subgraph matching function effectively localizes the query within the provenance graph. The overall graph-matching scores for each scenario is calculated by first merging all the returned ego-graphs into a single graph, G*. Then, the corresponding scores g(G*, GQ) is calculated, as described above. The resulting score values consistently exceeded 0.9, indicating a high degree of matching accuracy in all scenarios.

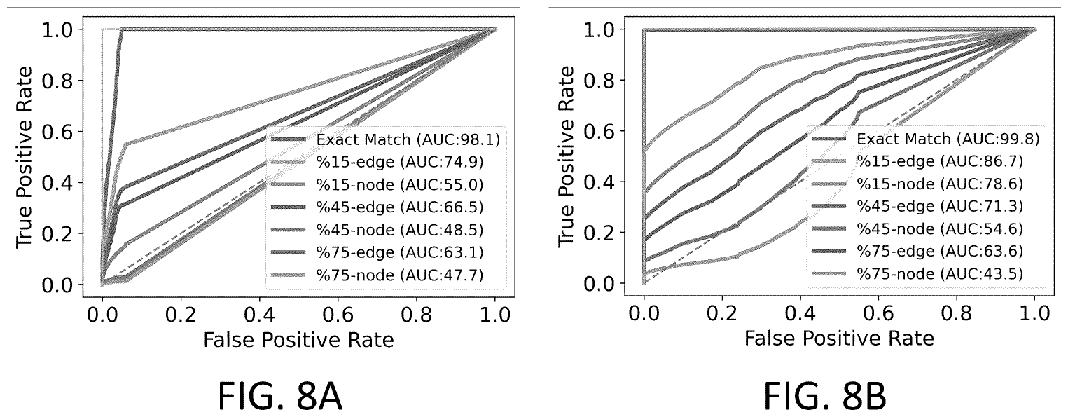

FIG. 8A shows the resulting ROC curves for subgraph matching scores using the present disclosure. FIG. 8B shows the resulting ROC curves for subgraph matching scores using a previous approach. The performance of ProvG-Searcher on a set of queries that include generic system behavior is also assessed. Ten batches of test samples consisting of 5-hop ego-graphs for both positive and negative samples from the Theia dataset are generated. The subgraph relationship is validated by calculating the order violation penalty, φ (zp, zq), between the ego-graphs of the provenance graph and those in the query. While evaluating the subgraph relationship, the threshold τovp is set to 0.04, which produces the highest accuracy. The matching ego-graphs are combined to create G* and calculate the final matching score, g(G*, GQ). The overall performance in determining whether the query graph is contained within the target graph results in an AUC value of 99.8.

To examine the robustness of the disclosed technique in handling imprecise queries, the same approach described above that randomly removes a portion of query edges and nodes in the provenance graphs is employed. As depicted in FIGS. 8A and 8B, the removal of 15% of edges leads to a 13% decrease in the model's accuracy. This demonstrates that the subgraph matching score in the present disclosure is sensitive to the alterations made in the input data, but still maintains a relatively high level of accuracy.

TABLE 3
Performance Comparison

| | Metrics | | | |
|---|---|---|---|---|
| Method | Accuracy | Precision | Recall | FPR |
| IsoRankN | 63.20 | 63.46 | 62.26 | 35.84 |
| SimGNN | 77.6 | 71.7 | 91.2 | 36.0 |
| DeepHunter | 80.8 | 78.5 | 84.7 | 23.2 |
| Poirot | 97.38 | 95.16 | 99.84 | 5.07 |
| PROVG-SEARCHER | 99.83 | 99.98 | 99.69 | 0.02 |

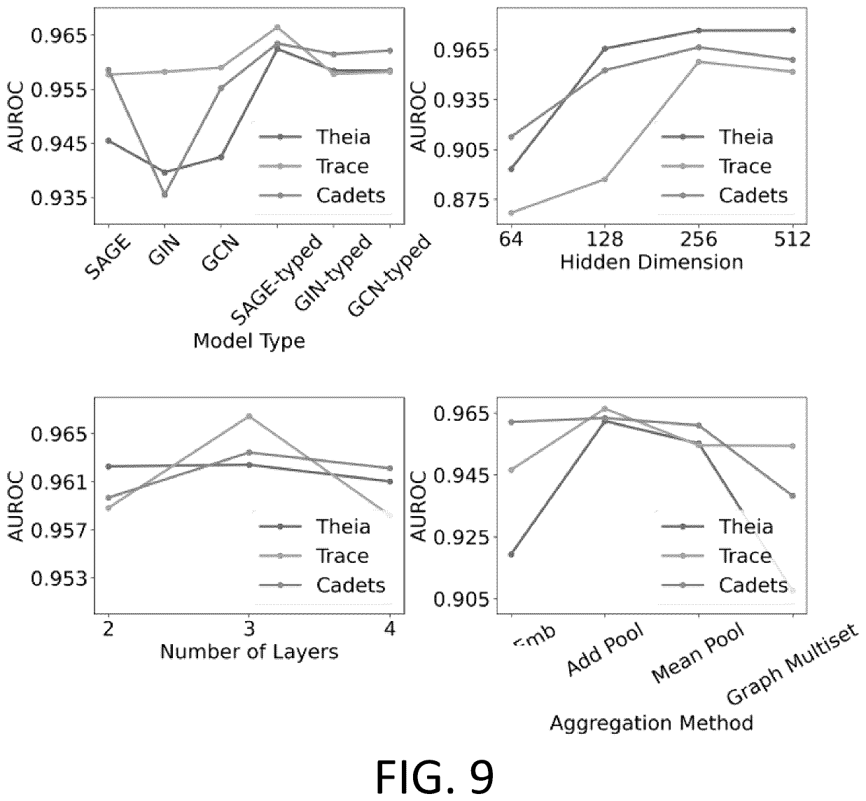

FIG. 9 shows a comparison of different GNN architectures, number of layers, and aggregation methods on Theia dataset. The performance of the subgraph prediction function on the Theia dataset is evaluated to determine the most suitable GNN architecture and optimal model parameters. The models are trained using 80% of the 3-hop ego-graphs and reserve 20% for testing. During the training phase, the test samples are not seen. The training on 400 batches with a batch size of 1024 is conducted, which includes an equal number of positive and negative target-query pairs. After the training, the models on 10 batches are evaluated.

To identify the most effective GNN architecture for the system, the performance of several well-known graph neural net-work architectures, such as GCN, GIN, and GraphSage, is assessed. Additionally, the multi-relation GNN architecture, where each edge type and direction are represented separately, is explored. The multi-relational GraphSage model, which integrates GraphSage with the Multi-Relation GNN, delivers the best performance among the tested architectures.

The impact of the number of layers and aggregation method used to obtain subgraph embeddings on the model's performance is analyzed. Although the performance differences are not substantial, using three layers yields the best results. In an alternate embodiment, a variety of pooling methods, such as add pooling, mean pooling, graph multiset pooling, and utilizing only the anchor node's embedding, are explored. The findings indicate that add pooling, which aggregates the embeddings of all nodes in the graph, surpasses the other pooling techniques. Further experiments are conducted to identify optimal values for batch size, scheduling scheme, weight decay parameter, and embedding size. The results reveal that, apart from the embedding size, the choice of other parameters does not significantly affect the performance. Improvements become marginal when the embedding size exceeds 256 dimensions.

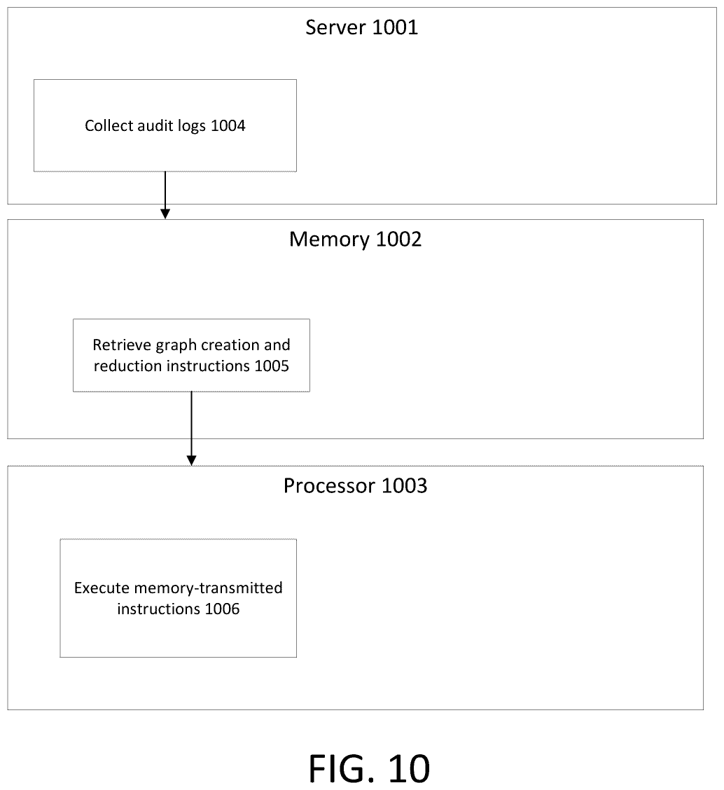

FIG. 10 is a component diagram of FIG. 1. The server 1001 collects audit logs 1004. The memory 1002 retrieve graph creation and reduction instructions 1005. The processor 1003 receives instructions 1005 from the memory 1002. Then the processor 1003 executes memory-transmitted instructions 1006.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for querying large provenance graph repositories comprising:
a server;
a processor; and
a memory storing instructions, which when executed by the processor, cause the processor to
apply an embedding function, and
apply a subgraph prediction function.

2. The system of claim 1, wherein the server receives kernel logs.

3. The system of claim 1, wherein the embedding function is a learned function that utilizes an inductive graph neural network with an order embedding technique and a max-margin loss, and wherein the embedding function is:
η: Gₚ→R^{d}, that maps each ego-graph Gₚ (Gₚ ⊆ [symbol] ) to a d-dimensional representation z∈R^{d}, where,
Gₚ: The k-hop ego-graph centered around node p. [symbol]
: The original provenance graph.
R^{d}: The d-dimensional real vector space.
z: The d-dimensional embedding vector corresponding to the ego-graph Gₚ.

4. The system of claim 1, wherein the subgraph prediction function is:
φ: R^{d}×R^{d}→{0, 1}, where,
R^{d}: The d-dimensional real space in which the embeddings zₚ and z_{q} are represented.
zₚ, z_{q}: The d-dimensional embeddings of ego-graphs Gₚ and G_{q}, respectively.
Gₚ, G_{q}: The k-hop ego-graph centered around nodes p and q, respectively.
φ(zₚ, z_{q})=1: Indicates that Gₚ is a subgraph of G_{q}.
φ(zₚ, z_{q})=0: Indicates that Gₚ is not a subgraph of G_{q}.

5. A method for querying large provenance graph repositories comprising:
receiving kernel logs from a server;
converting kernel logs to a graph representation;
simplifying the graph representation;
versioning nodes in the graph representation;
partitioning the nodes into overlapping subgraphs; and
identifying a subgraph relation of the overlapping subgraphs.

6. The method of claim 5, wherein converting kernel logs to a graph representation comprises applying a converting function, the converting function being: [symbol]
: [symbol] → [symbol] where [symbol] represents the set of kernel logs, and [symbol] =( [symbol] ,ε) represents the graph. A graph [symbol] is defined as a set of nodes V=v₁, . . . , v_{N} and a set of edges ε=e₁, . . . , e_{M} where each node and each edge are associated with a type.
a. Each node vᵢ ∈ [symbol] is labeled with a system entity identifier and typed based on the nature of the entity it represents, such as a process, file, or network socket.
b. Each directed edge eⱼ∈ε represents the flow of information between nodes, corresponding to a specific event that occurred, and is labeled with the event type and timestamp.
The converting function [symbol] processes each kernel log entry l∈ [symbol] to determine the corresponding nodes and edges in the graph [symbol] . For a given log entry (lₖ), the function identifies the involved system entities, assigns them to nodes in [symbol] , and maps the system event and timestamp to an edge in ε. Formally, for each log entry lₖ ∈ [symbol] , the converting function (f) defines: f(lₖ)=(v_{src},v_{dst},eₖ) where v_{src} and v_{dst} are the source and destination nodes respectively, corresponding to the entities involved in the edge, and eₖ is the directed edge with event type and timestamp.

7. The method of claim 5, wherein simplifying the graph representation comprises applying a simplifying function, the simplifying function being: [symbol]
( [symbol] )=( [symbol] ′,ε′), where ( [symbol] =( [symbol] ,ε)) is the original graph, ( [symbol] ′⊆ [symbol] ) and (ε′⊆ε). The function(S) operates by merging nodes and edges based on specific criteria to reduce the complexity of the graph while maintaining the essential temporal dependencies. Specifically:
a. Node Merging: Nodes (vᵢ) and (vⱼ) are merged into a single node (vₖ) if they represent the same network entity at different time points and their timestamps are within a predefined time window (Δt). Formally,
vₖ=vᵢ∪vⱼ if |tᵢ−tⱼ|≤Δt where (tᵢ) and (tⱼ) are the timestamps associated with connection events related to (vᵢ) and (vⱼ) respectively.
b. Edge Simplification: The edge set (ε′) is derived by aggregating edges that connect merged nodes. If (vᵢ,vⱼ) and (vₘ,vₙ) are edges in (ε) and (vᵢ) and (vₘ) are merged into (vₖ), then the edges are simplified to (vₖ,vⱼ) or (vₖ,vₙ) based on the preservation of the temporal order.
c. Timestamp Propagation: Each merged node (vₖ) inherits the earliest timestamp from its constituent nodes to ensure the causal order is preserved. Thus, tₖ=min (tᵢ,tⱼ) when (vₖ) is the source node, otherwise tₖ=max(tᵢ,tⱼ)
Therefore, the simplified graph ( [symbol] ′) retains the critical temporal structure of the original graph while reducing its complexity, making it more efficient for further analysis.

8. The method of claim 5, wherein versioning nodes in the graph representation comprises applying a versioning function, the versioning function being: [symbol]
ᵥ: [symbol] × [symbol] → [symbol] ᵥ where ( [symbol] ) is the set of nodes, ( [symbol] ) is the set of timestamps, and ( [symbol] ᵥ) is the set of versioned nodes. The function ( [symbol] ᵥ) maps a node (v∈ [symbol] ) and a timestamp (t∈ [symbol] ) to a versioned node (vᵥ∈ [symbol] ᵥ):
a. Node Update: When node (v) receives new information at time (t), create (vᵥ=(v,t)).
b. Path Consistency: For any path (P) in an ego-graph, edges must have:
$${t}_{i} < {t}_{i + 1} \qquad \begin{matrix}∀ , {t}_{i} , {t}_{i + 1} & ∈ 𝒯\end{matrix}$$
c. Edge Representation: For an edge (e) between nodes (vᵥ₁=(v₁,t₁)) and (vᵥ₂=(v₂,t₂): t₁<t₂
This preserves causal order and temporal integrity in the provenance graph.

9. The method of claim 5, wherein partitioning the nodes into overlapping subgraphs comprises applying a partitioning function, the partitioning function being:
P: [symbol] × [symbol] ×Z⁺→{Gₚ|p∈ [symbol] }, where, [symbol]
: The set of process nodes in the graph [symbol] . [symbol]
: The original provenance graph.
k∈Z⁺: The depth of the ego-graph.
Gₚ: The k-hop ego-graph centered around the node p, such that:
Gₚ={v∈ [symbol] |distance(p, v)≤k} where,
distance(p, v): is the shortest path length between node p and any other node v.

10. The method of claim 5, wherein identifying the subgraph relation of the overlapping subgraphs comprises training positive and negative pairs of graphs through an embedding function and a subgraph prediction function.

11. The system of claim 10, wherein the embedding function is:
η: Gₚ→R^{d}, that maps each ego-graph (Gₚ⊆ [symbol] ) to a d-dimensional representation z∈R^{d}, where,
Gₚ: The k-hop ego-graph centered around node p. [symbol]
: The original provenance graph.
R^{d}: The d-dimensional real vector space.
z: The d-dimensional embedding vector corresponding to the ego-graph Gₚ.

12. The system of claim 10, wherein the subgraph prediction function is:
φ: R^{d}×R^{d}→{0, 1}, where,
R^{d}: The d-dimensional real space in which the embeddings z_{P} and z_{Q} are represented.
zₚ, z_{q}: The d-dimensional embeddings of ego-graphs Gₚ and G_{q}, respectively.
Gₚ, G_{q}: The k-hop ego-graph centered around nodes p and q, respectively.
φ(zₚ, z_{q})=1: Indicates that Gₚ is a subgraph of G_{q}.
φ(zₚ, z_{q})=0: Indicates that Gₚ is not a subgraph of G_{q}.
